(19) United States
(12) Patent Application Publication
(10) Pub. No.: US 2013/0239400 A1
(43) Pub. Date: Sep. 19, 2013

(54) Method of Manufacturing Continuously Variable Transmission Variator Component and Chuck Apparatus for Manufacturing Variator Component

(71) Applicant: Shouji Yokoyama, Hanyu-shi (JP)

(72) Inventor: Shouji Yokoyama, Hanyu-shi (JP)

(73) Assignee: NSK Ltd., Shinagawa-ku, Tokyo (JP)

(21) Appl. No.: 13/581,253

(22) PCT Filed: Dec. 9, 2011
(86) PCT No.: PCT/JP2011/006894

§ 371 Date: Oct. 9, 2012

(30) Foreign Application Priority Data
Dec. 10, 2010 (JP) 2010-275721

(51) Int. Cl. B23B 31/16; B23P 13/00

(52) U.S. Cl. CPC B23B 31/1627; B23P 13/00
USPC 29/558; 279/2.21

(57) ABSTRACT

Provided is a method of manufacturing a variator component comprising a step of performing, on a variator component workpiece, pre-machining of a power transmission surface and spline holes while leaving machining allowance, a step of performing workpiece thermal hardening, a step of performing finish-machining of multiple spline grooves constituting the workpiece spline holes, a step of snugly abutting part of a chuck mounted on a lathe or a grinder into multiple spline grooves and clamping the workpiece coaxially with the rotational axis of the chuck, and a step of performing finish-machining of the power transmission surface of the workpiece using ball spline grooves of the workpiece clamped by the collet chuck as a machining reference.

### TECHNICAL FIELD

The present invention relates to a method of manufacturing a component of an automotive continuously variable transmission variator and to a chuck apparatus for manufacturing the variator component.

### BACKGROUND ART

As shown in FIG. 12, ball splines are provided between a power transmission shaft 2 for transmitting rotation from an engine and an input disk 1 that is a component of the variator of a toroidal continuously variable transmission. These ball splines enable the input disk 1 to rotate in synchronization with the power transmission shaft 2 and also move relative to the axial direction of the power transmission shaft 2.

As shown in FIG. 13, cylindrical portions 3a and ball spline grooves 3b are alternately formed in the circumferential direction on a cylindrical inner diameter portion 3 of the input disk 1. Further, around the outer periphery of the input disk 1 are formed a traction surface 4 that is a power transmission surface opposing power rollers (not shown), a first back surface 5 for countering the thrust load that is a surface on the opposite side in the axial direction from the traction surface 4 and a second back surface 6 for countering the thrust load that is a surface on the opposite side in the axial direction from the traction surface 4 and located at the rim of the cylindrical inner diameter portion 3.

Further, multiple ball spline grooves 2a are formed around the power transmission shaft 2 at a prescribed gap in the circumferential direction.

Then, the ball spline grooves 2a of the power transmission shaft 2 and the ball spline grooves 3b of the input disk 1 are opposite to each other, so that balls 7 are accommodated between the paired ball spline grooves 2a and 3b to configure ball splines that engage the input disk 1 and the power transmission shaft 2.

Here, as shown in FIG. 13, gaps 8 are formed between the cylindrical portions 3a of the input disk 1 and an outer diameter portion of the power transmission shaft 2, and since the radial position of the input disk 1 is therefore constrained solely by the ball splines, the traction surface 4 of the input disk 1 has to be machined to have high coaxial and perpendicular properties with respect to the ball spline grooves 3b. Further, the first and second back surfaces 5 and 6 of the input disk 1 have to be machined to have a high perpendicular property with respect to the ball spline grooves 3b.

As methods of manufacturing a variator component of a continuously variable transmission, for example, the techniques described in Patent Documents 1 to 3 are known.

### PRIOR ART DOCUMENTS

### Patent Documents

Patent Document 1: JP 2002-28818 A
Patent Document 2: JP 2000-61494 A
Patent Document 3: JP 2001-347443 A

### SUMMARY OF THE INVENTION

### Problem to be Solved

Patent Document 1 describes machining of the traction surface using spline tooth surfaces formed on the cylindrical inner diameter portion of the disk, as the machining reference. However, Patent Document 1 does not disclose any concrete technique regarding how the spline tooth surfaces are engaged and the coaxial and perpendicular properties of the traction surface is enhanced Therefore, the coaxial and perpendicular properties of the traction surface with respect to the spline tooth surfaces cannot be ensured.

Besides, Patent Document 2 describes the use of a hard broaching tool to alternately form cylindrical portions and ball spline grooves in the circumferential direction of the disk inner diameter portion and enhancement of the coaxiality and perpendicularity of the traction surface using the cylindrical portion as the machining reference. However, Patent Document 2 needs a hard broaching tool formed coaxially at high accuracy with forming teeth for forming the cylindrical portion of the disk inner diameter portion and forming teeth for forming the ball spline grooves, so that disk manufacturing cost may be increased owing to additional processes.

In addition, Patent Document 3 describes that a chuck mechanism is mounted for centering by engaging ball spline grooves formed in the disk inner diameter portion with balls and machining of the traction surface is performed via the chuck mechanism using the ball spline grooves as the machining reference. However, Patent Document 2 also fails to disclose any concrete technique regarding how the chuck mechanism holds the ball spline grooves and the coaxial and perpendicular properties of the traction surface is enhanced. Therefore, the coaxial and perpendicular properties of the functional surface with respect to the ball spline grooves cannot be ensured.

The present invention has been made in the light of the foregoing circumstances and has an object to provide a method of manufacturing a component of a continuously variable transmission variator and a chuck apparatus for manufacturing the variator component, so that the power transmission surface can be machined with enhanced coaxial and perpendicular properties with respect to finish-machined spline grooves in the central inner diameter portion and working cost can be reduced.

### Solution to the Problem

In order to achieve the aforesaid object, according to an embodiment of the present invention, there is provided a method of manufacturing a continuously variable transmission variator component, the method comprising the steps of: performing, on a workpiece of the continuously variable transmission variator component, pre-machining of a power transmission surface on one side surface while leaving a machining allowance and pre-machining of spline holes for engaging a power transmission shaft in a central inner diameter portion while leaving machining allowance; performing a thermal hardening process on the workpiece; finish-machining of a plurality of spline grooves constituting the workpiece spline holes; snugly abutting a part of a chuck mounted on a lathe or a grinder into the plurality of spline grooves and clamping the workpiece to make a rotational axis of the chuck and centers of the plurality of spline grooves of the workpiece coaxial; and finish-machining of the power transmission surface of the workpiece using the spline grooves of the workpiece clamped by the chuck as a machining reference.

Here, each of the centers of the plurality of spline grooves denotes the center of the spline groove inner diameter (BBD): Between Ball Diameter).

By the method of manufacturing the continuously variable transmission variator component according to the present embodiment, it is possible to produce a variator component whose power transmission surface is enhanced in coaxial and perpendicular properties with respect to the spline grooves. Further, there is no increase in the number of processing steps in order to enhance the coaxial and perpendicular properties of the power transmission surface with respect to the spline grooves.

Further, according to an aspect of the present invention, the method of producing the continuously variable transmission variator component may further comprising finish-machining of another side surface of the workpiece using the spline grooves of the workpiece clamped by the chuck as the machining reference.

By the method of manufacturing the continuously variable transmission variator component according to an aspect of the present invention, it is possible to produce a variator component having another side surface enhanced in the perpendicular property with respect to the spline grooves.

Further, according to an aspect of the present invention, the method of producing the continuously variable transmission variator component may further comprise finish-machining of an end face of the workpiece using the spline grooves of the workpiece clamped by the chuck as the machining reference.

By the method of manufacturing the continuously variable transmission variator component according to an aspect of the present invention, it is possible to produce a variator component having an end face enhanced in the coaxial property with respect to the spline grooves.

Further, according to an aspect of the present invention, in the method of producing the continuously variable transmission variator component, the chuck may comprise: a plurality of radially expandable pieces formed by circumferentially dividing a hollow cylindrical member; a plurality of clamp ridges formed on the outer peripheries of prescribed radially expandable pieces corresponding to the plurality of spline grooves to be projected into contact with groove surfaces of the spline grooves: and a radial expansion shaft snugly abutted on the plurality of spline grooves respectively corresponding to the plurality of clamp ridges.

By the method of manufacturing the continuously variable transmission variator component according to an aspect of the present invention, owing to the provision of the chuck expands and holds the multiple radially expandable pieces to abut the individual multiple clamp ridges snugly in the individual associated spline grooves, by insertion of the radial expansion shaft within the multiple radially expandable pieces, it is possible to mount the workpiece on a lathe or a grinder with the enhanced coaxial property.

Further, according to an aspect of the present invention, in the method of manufacturing the continuously variable transmission variator component, the chuck may comprise: a radially expandable section provided with a plurality of radially expandable pieces formed by circumferentially dividing a hollow cylindrical member provided with a fluid passage at an axial position; and a plurality of clamp ridges formed on the outer peripheries of prescribed radially expandable pieces corresponding to the plurality of spline grooves to be projected into contact with groove surfaces of the spline grooves, and the plurality of radially expandable pieces expand and hold the plurality of radially expandable pieces to abut the plurality of clamp ridges snugly in the spline grooves, respectively, upon supply of a fluid into the fluid passage.

By the method of manufacturing a continuously variable transmission variator component according to an aspect of the present invention, owing to the provision of the chuck whereby supply of a fluid into the fluid passage expands and holds the multiple radially expandable pieces to abut the multiple clamp ridges snugly in the spline grooves, respectively, it is possible to mount the workpiece on a lathe or a grinder with the enhanced coaxial property.

Further, according to an aspect of the present invention, in the method of manufacturing a continuously variable transmission variator component, the chuck may comprises: a shaft portion having a tapered outer peripheral surface: and a plurality of clamp ridges formed on the tapered outer peripheral surface at a prescribed gap in a circumferential direction at positions respectively corresponding to the plurality of spline grooves to project into contact with the groove surfaces of the spline grooves, and the plurality of clamp ridges are respectively abutted snugly in the spline groves by insertion of the tapered outer peripheral surface of the shaft portion into the central inner diameter portion.

By the method of manufacturing the continuously variable transmission variator component according to an aspect of the present invention, owing to the provision of the chuck that abuts the multiple clamp ridges snugly in the individual associated spline groves upon insertion of the tapered outer peripheral surface of the shaft portion into the central inner diameter portion, it is possible to mount the workpiece on a lathe or a grinder with the enhanced coaxial property.

Further, according to an aspect of the present invention, there is provided a method of manufacturing a continuously variable transmission variator component the method comprising: performing, on a workpiece of the continuously variable transmission variator component, pre-machining of a power transmission surface on one side surface while leaving a machining allowance and pre-machining of spline holes for engaging a power transmission shaft in a central inner diameter portion while leaving the machining allowance; performing a thermal hardening process on the workpiece; finish-machining of a plurality of spline grooves constituting the workpiece spline holes; snugly abutting a part of a chuck mounted on a lathe or a grinder against the plurality of spline grooves and clamping the workpiece to make a rotational axis of the chuck and centers of the plurality of spline grooves of the workpiece coaxial; finish-machining of another side surface of the workpiece using the spline grooves of the workpiece clamped by the chuck as a machining reference; and finish-machining of a power transmission surface of the workpiece using the another side surface of the workpiece as the machining reference.

By the method of manufacturing the continuously variable transmission variator component according to an aspect of the present invention, it is possible to produce a variator component whose power transmission surface is enhanced in coaxial and perpendicular properties with respect to the spline grooves by finish-machining of the other side surface of the work using the spline grooves of the work clamped by the chuck as the working surface and finish-machining of the power transmission surface of the work using this other side surface of the work as the working reference.

On the other hand, according to an aspect of the present invention, there is provided a chuck apparatus for manufacturing a variator component, the chuck apparatus comprising: a plurality of radially expandable pieces formed by circumferentially dividing a hollow cylindrical member; a plurality of clamp ridges that project outward from the outer peripheries of the plurality of radially expandable pieces; and a radial expansion shaft that expands and holds the plurality of radially expandable pieces by insertion within the plurality of radially expandable pieces, wherein, at the time of mounting on a lathe or a grinder the workpiece of a continuously variable transmission variator component, in which a plurality of spline groove holes to be engaged with a power transmission shaft in a circumferential direction of a central inner diameter portion have been finish-machined, and performing finish-machining of a part other than the plurality of spline grooves of the workpiece, the plurality of clamp ridges are snugly abutted in the plurality of spline grooves of the workpiece, respectively, by inserting the radial expansion shaft mounted at a rotational center of the lathe or the grinder in the plurality of radially expandable pieces.

By the chuck apparatus for manufacturing a variator component according to an aspect of the present invention, it is possible to mount the workpiece on a lathe or a grinder with the enhanced coaxial property.

Further, according to an aspect of the present invention, there is provided a chuck apparatus for manufacturing a variator component, the chuck apparatus comprising: a radially expandable section provided with a plurality of radially expandable pieces formed by circumferentially dividing a hollow cylindrical member provided with a fluid passage at an axial center position; and a plurality of clamp ridges that project outward from the outer peripheries of the plurality of radially expandable pieces, wherein, at the time of mounting on a lathe or a grinder the workpiece of a continuously variable transmission variator component, in which a plurality of spline groove holes to be engaged with a power transmission shaft in a circumferential direction of a central inner diameter portion have been finish-machined, and performing finish-machining of a part other than the spline grooves of the workpiece, the plurality of clamp ridges are snugly abutted in the plurality of spline grooves of the workpiece, respectively, by mounting the radially expandable section at the rotational center of the lathe or the grinder and supplying a fluid into the fluid passage to expand and hold the plurality of radially expandable pieces.

By the chuck apparatus for manufacturing a variator component according to an aspect of the present invention, it is possible to mount the workpiece on a lathe or a grinder with the enhanced coaxial property.

Further, according to an aspect of the present invention, there is provided a chuck apparatus for manufacturing a variator component, the chuck apparatus comprising: a shaft portion having a tapered outer peripheral surface; and a plurality of clamp ridges that project at a prescribed gap in a circumferential direction of the tapered outer peripheral surface, wherein, at the time of mounting on a lathe or a grinder the workpiece of a continuously variable transmission variator component, in which a plurality of spline groove holes to be engaged with a power transmission shaft in a circumferential direction of a central inner diameter portion have been finish-machined, and performing finish-machining of apart other than the plurality of spline grooves of the workpiece, the plurality of clamp ridges are snugly abutted in the plurality of spline grooves of the workpiece, respectively, by inserting the shaft portion mounted at the rotational center of the lathe or the grinder into the centeral inner diameter portion.

By the chuck apparatus for manufacturing the variator component according to the present embodiment, it is possible to mount the workpiece on a lathe or a grinder with the enhanced coaxial property.

### Advantageous Effects of the Invention

By the method of manufacturing a continuously variable transmission variator component according to the present invention, it is possible to produce a variator component whose power transmission surface is enhanced in coaxial and perpendicular properties with respect to the spline grooves. Further, as there is no increase in the number of processing steps in order to enhance the coaxial and perpendicular properties of the power transmission surface with respect to the spline grooves, it is possible to reduce the manufacturing cost of the variator component.

Further, by the chuck apparatus for manufacturing a variator component according to the present invention, it is possible to mount a workpiece on a lathe or a grinder with the enhanced coaxial property.

### BRIEF DESCRIPTION OF THE DRAWINGS

FIG. 1A to FIG. 1D are diagrams showing processing steps of a method of manufacturing a continuously variable transmission variator component according to a first embodiment of the present invention;

FIG. 2 is a diagram schematically illustrating a chuck (collet chuck) used in the method of the first embodiment;

FIG. 3 is a diagram showing the state of the chuck snugly abutted in workpiece spline grooves in the method of the first embodiment;

FIG. 4 is diagram showing a master cylinder for correcting swing of multiple radially expandable pieces of the chuck in the first embodiment;

FIG. 5A and FIG. 5B are diagrams showing another way of using the first embodiment;

FIG. 6A and FIG. 6B are diagrams showing a method of manufacturing a continuously variable transmission variator component according to a second embodiment differing in the structure of the chuck;

FIG. 7A and FIG. 7B are diagrams showing a method of manufacturing a continuously variable transmission variator component according to a third embodiment differing in the structure of the chuck;

FIG. 8 is a diagram showing an upstream processing step of a method of manufacturing a component of the variator of a toroidal continuously variable transmission according to a fourth embodiment;

FIG. 9A and FIG. 9B are diagrams showing a downstream processing step of the method of manufacturing a component of the variator of a toroidal continuously variable transmission according to the fourth embodiment;

FIG. 10 is a diagram showing an upstream processing step of a method of manufacturing a component of the variator of a belt-type continuously variable transmission according to the fourth embodiment;

FIG. 11A and FIG. 11B are diagrams showing a downstream processing step of the method of manufacturing a component of the variator of a belt-type continuously variable transmission according to the fourth embodiment;

FIG. 12 is a diagram showing the state of engagement between a continuously variable transmission variator component and a ball spline of a power transmission shaft; and

FIG. 13 is a diagram showing the ball spline engagement state in a sectional view.

### DESCRIPTION OF EMBODIMENTS

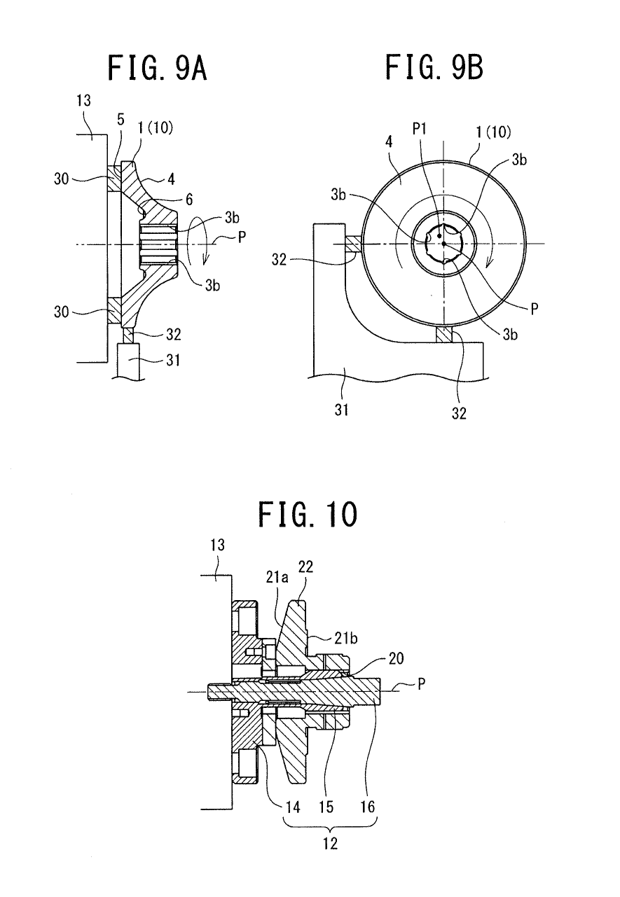

Modes of implementing the present invention (hereinafter called embodiments) are explained in detail below with reference to the drawings. Note that constituent portions the same as the constituents shown in FIG. 8 and FIG. 9 are assigned like symbols and explanation thereof is omitted.

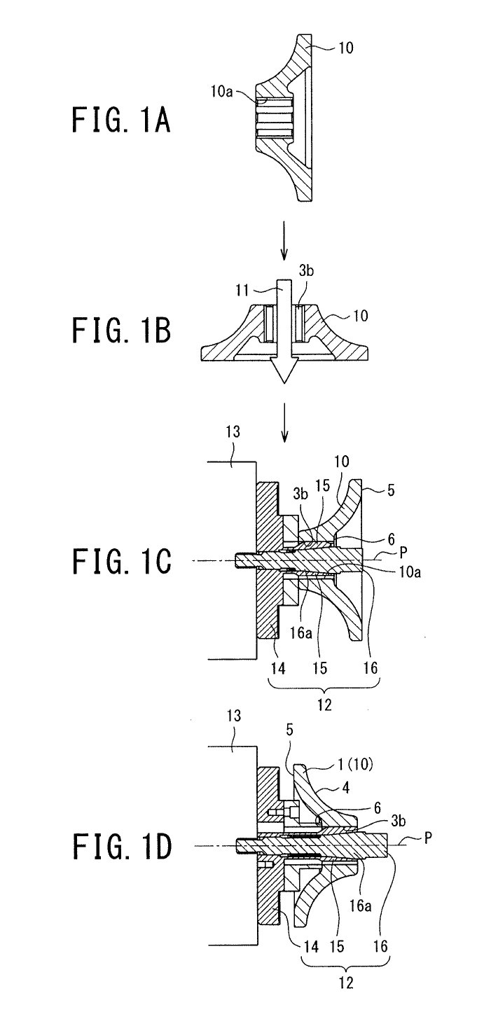

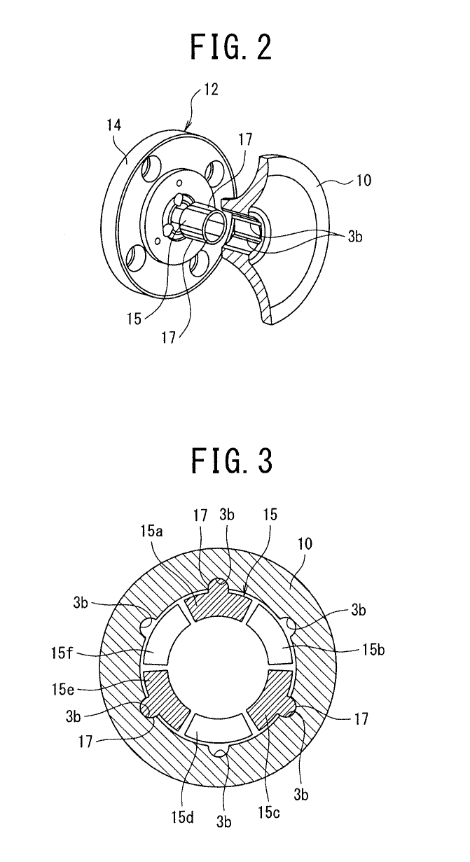

FIG. 1A to FIG. 1D show an embodiment of a method of manufacturing an input disk that is a component of the variator of a toroidal continuously variable transmission, according to the present invention. FIG. 2 to FIG. 4 show a structure of a collet chuck 12 used in the present embodiment.

In the method of manufacturing an input disk of the present embodiment, pre-working and heat treatment are firstly performed in FIG. 1A. In the pre-working, a workpiece 10 is formed by hot forging to an approximate shape with a machining allowance with respect to the finished dimensions. Next, cutting is performed to machine the outer shape of the workpiece 10 to a shape with an optimum machining allowance in consideration of the heat treatment strain. Next, the cylindrical inner diameter portion 10a of the workpiece 10 is formed to a shape of prescribed dimensions by broach machining. Then, the workpiece 10 formed by the cutting and broach machining is hardened by heat treatment.

Next, as shown in FIG. 1B, a hard broach tool 11 is used for finish-machining of multiple ball spline grooves 3b at prescribed intervals in the circumferential direction of the cylindrical inner diameter portion 10a of the workpiece 10. It should be noted that the hard broach tool 11 can be used to simultaneously finish-machine the ball spline grooves 3b and cylindrical portions 3a.

Next, as shown in FIG. 1C, the workpiece 10 is clamped by a collet chuck 12 mounted on a lathe drive section 13, with a large diameter portion (the first back surface 5 side) facing outward. The lathe drive section 13 is rotationally driven to finish-machine the first back surface 5 and second back surface 6 of the workpiece 10 to have a high perpendicular property with respect to the ball spline grooves 3b using the ball spline grooves 3b formed in the cylindrical inner diameter portion 10a of the workpiece 10, as the machining reference.

The structure of the collet chuck 12 will be explained next.

As shown in FIG. 1C, the collet chuck 12 is provided with a chuck body 14 mounted on the lathe drive section 13, a radially expandable clamp section 15 of hollow cylindrical shape projecting from the side surface of the chuck body 14 and capable of radial expansion for engagement with the cylindrical inner diameter portion 10a of the workpiece 10, and a radial expansion shaft 16 for expanding the radially expandable clamp section 15.

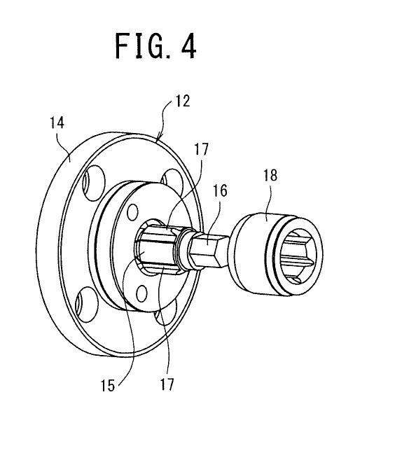

As shown in FIG. 2 and FIG. 3, the radially expandable clamp section 15 includes radially expandable pieces 15a to 15f multi-divided in the circumferential direction, and the outer peripheries of prescribed radially expandable pieces 15a, 15c and 15e are formed with clamp ridges 17 whose crest shape is the same as the shape of the multiple ball spline grooves 3b formed in the cylindrical inner diameter portion 10a of the workpiece 10.

As shown in FIG. 1C, the radial expansion shaft 16 is formed with a tapered portion 16a that abuts on the inner diameter portion of the radially expandable pieces 15a to 15f.

Note that the chuck of the present invention corresponds to the collet chuck 12.

The cylindrical inner diameter portion 10a of the workpiece 10 is fitted onto the radially expandable clamp section 15 of the collet chuck 12 of the aforesaid structure with the large diameter portion (the first back surface 5 side) facing outward. The chuck body 14 of the collet chuck 12 united with the workpiece 10 is mounted coaxially with the rotational center of the lathe drive section 13, and the tip portion of the radial expansion shaft 16 inserted into the radially expandable clamp section 15 is engaged with the axis position of the lathe drive section 13. Then, the tapered portion 16 of the radial expansion shaft 16 radially expands the radially expandable pieces 15a to 15f to snugly fit the clamp ridges 17 of the radially expandable pieces 15a, 15c and 15e in the multiple ball spline grooves 3b of the workpiece 10, so that the workpiece 10 is clamped coaxially with the rotational center P of the lathe drive section 13, and the multiple ball spline grooves 3b of the workpiece 10 assume a state of extending in parallel with the rotational center P of the lathe drive section 13.

With perpendicularity thus having been enhanced with respect to the ball spline grooves 3b extended in parallel at the rotational center of the lathe drive section 13, finish-machining of the first back surface 5 and second back surface 6 of the workpiece 10 is performed.

Next, as shown in FIG. 1D, the workpiece 10 is clamped on the lathe drive section 13 via the collet chuck 12 with the large diameter portion (the first back surface 5 side) facing the lathe drive section 13 side.

Also in this case, as regards the structure of the collet chuck 12 and its method of use, the procedure is the same as shown in FIG. 1C. The clamp ridges 17 of the radially expandable pieces 15a, 15c and 15e of the collet chuck 12 clamping the workpiece 10 with the large diameter portion facing the lathe drive section 13 side are snugly fit into the multiple ball spline grooves 3b of the workpiece 10. Accordingly, the multiple ball spline grooves 3b extend in parallel with the rotational center P of the lathe drive section 13, and the rotational center P and the center of the inner diameter (BBD) of the ball spline grooves 3b become coaxial.

With coaxial and perpendicular properties thus having been enhanced with respect to the ball spline grooves 3b extended in parallel at the rotational center of the lathe drive section 13, finish-machining of the traction surface 4 of the workpiece 10 is performed.

Therefore, with the collet chuck 12 of the present embodiment, by snugly fitting into the ball spline grooves 3b formed in the cylindrical inner diameter portion 10a the clamp ridges 17 formed on the radially expandable clamp section 15 in the same shape as the ball spline grooves 3b. Thus, the workpiece 10 is clamped to extend in parallel with the rotational center P of the lathe drive section 13. It is therefore possible to produce an input disk 1 formed with a traction surface 4, the first back surface 5 and the second back surface 6 that are enhanced in coaxial and perpendicular properties with respect to the ball spline grooves 3b.

Further, the coaxial and perpendicular properties of the traction surface 4, the first back surface 5 and the second back surface 6 can be enhanced without need to machine a reference surface for the inner and outer diameters, the first back surface 5, and the second back surface 6 before the hard broach machining and without increasing the number of processing steps, so that the manufacturing cost of the input disk 1 can be reduced.

It should be noted that a method of manufacturing an input disk 1 formed with the traction surface 4, the first back surface 5 and the second back surface 6 has been explained in the present embodiment. However, even in a case where the end face of the input disk 1 is to be formed using the ball spline grooves 3b as a machining reference, it is possible also to enhance the perpendicularity of the end face with respect to the ball spline grooves.

Further, the circumferentially multi-divided radially expandable pieces 15a to 15f constituting the radially expandable clamp section 15 of the collet chuck 12 may swing in the circumferential direction. Hence, as shown in FIG. 4, the circumferential swing of the radially expandable pieces 15a to 15f can be corrected by fitting on the radially expandable clamp section 15, a master cylinder 18 having an internal diameter configuration of the same design as the cylindrical inner diameter portion 3 finish-machined in the cylindrical inner diameter portion 10a (same center of pitch, center of outer diameter, etc. as the ball spline grooves 3b).

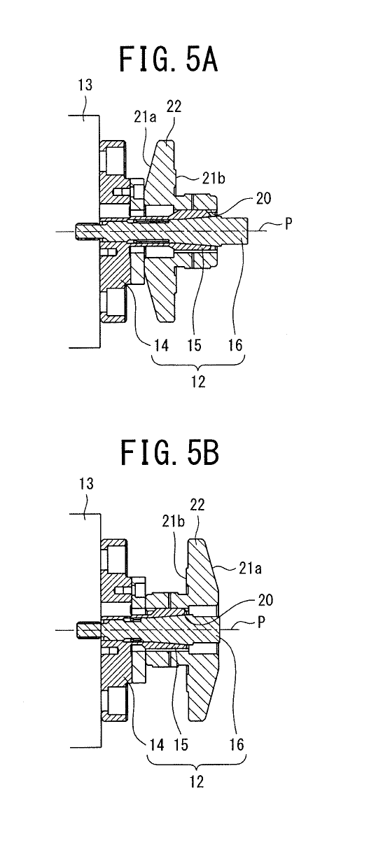

Further, a method of manufacturing an input disk 1 that is a toroidal continuously variable transmission variator component has been explained in the present embodiment. As shown in FIG. 5A and FIG. 5B, however, the collet chuck 12 of the present embodiment is applicable to a pulley 22 that is a belt-type continuously variable transmission variator component having ball spline grooves 20 formed in a cylindrical inner diameter portion and provided on a side surface with a pulley surface 21a as a functional surface and on the opposite side from the pulley surface 21a with a back surface 21b as a functional surface. Specifically, the clamp ridges 17 formed on the radially expandable clamp section 15 are snugly fit into the ball spline grooves 20 formed in the cylindrical inner diameter portion, so that the blank (pulley 22) is clamped to extend in parallel with the rotational center P of the lathe drive section 13, thus enabling manufacturing of a pulley 22 with a pulley surface 21a and back surface 21b enhanced in coaxial and perpendicular properties with respect to the ball spline grooves 20.

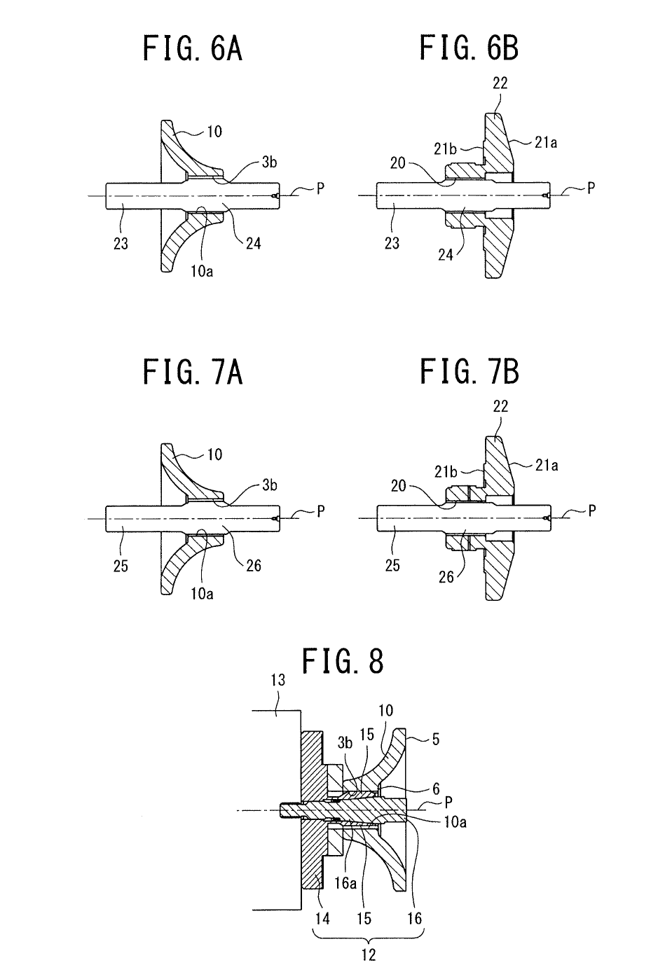

Next, shown in FIG. 6A is a chuck of a different structure from the collet chuck 12 shown in FIG. 1 to FIG. 5. Note that component parts the same as those shown in FIG. 1 to FIG. 5 are assigned like symbols and explanation thereof will be omitted.

The chuck 23 according to the present embodiment clamps the workpiece 10 on which the pre-working and heat treatment shown in FIG. 1A have been completed and the hard broach machining shown FIG. 1B has been completed. Further, the chuck 23 according to the present embodiment is rotated around the rotational center P by the lathe drive section 13.

The chuck 23 is provided with a radially expandable clamp section 24 equipped with multiple radially expandable pieces formed by circumferentially dividing a hollow cylindrical member including a fluid passage (not shown) at the axial position. The radially expandable pieces are of substantially the same shape as the radially expandable pieces 15a to 15f shown in FIG. 3. The prescribed radially expandable pieces are formed with clamp ridges of the same shape as in FIG. 3 to project in the same shape as the groove shape of the ball spline grooves 3b.

In the radially expandable clamp section 24 of the chuck 23 of the present embodiment, a fluid is supplied to the fluid passage to expand and hold the multiple radially expandable pieces and snugly fit the clamp ridges formed on the prescribed radially expandable pieces in the ball spline grooves 3b formed in the cylindrical inner diameter portion 10a. Hence, the workpiece 10 is clamped to extend in parallel with the rotational center P of the lathe drive section 13. This enables manufacturing of an input disk 1 formed with a traction surface 4, the first back surface 5 and the second back surface 6 that are enhanced in coaxial and perpendicular properties with respect to the ball spline grooves 3b.

It should be noted that as shown in FIG. 6B, also with respect to the pulley 22 that is a component of the variator of a belt-type continuously variable transmission, the chuck 23 according to the present embodiment snugly fits the clamp ridges formed on the prescribed radially expandable pieces according to the present embodiment in the ball spline grooves 20 of the pulley 22. This make it possible to form a pulley surface 21a and back surface 21b that are enhanced in coaxial and perpendicular properties with respect to ball spline grooves 20.

Further, shown in FIG. 7A is a chuck of another different structure.

The chuck 25 according to the present embodiment is formed with a tapered outer peripheral surface 26. Multiple clamp ridges that project in the same shape as the shape of as the groove shape of the ball spline grooves 3b are formed on the tapered outer peripheral surface 26 at a prescribed gap in the circumferential direction. These clamp ridges are regions of the same shape as in FIG. 3.

And with the chuck 25 according to the present embodiment, when the tapered outer peripheral surface 26 is inserted into the cylindrical inner diameter portion 10a, the clamp ridges formed on the tapered outer peripheral surface 26 snugly fit in the ball spline grooves 3b formed in the cylindrical inner diameter portion 10a, whereby the workpiece 10 is clamped to extend in parallel with the rotational center P of the lathe drive section 13. This enables manufacturing of an input disk 1 formed with a traction surface 4, the first back surface 5 and the second back surface 6 that are enhanced in coaxial and perpendicular properties with respect to the ball spline grooves 3b.

It should be noted that as shown in FIG. 7B, also with respect to the pulley 22 that is a component of the variator of a belt-type continuously variable transmission, the chuck 25 according to the present embodiment snugly fits the clamp ridges formed on the tapered outer peripheral surface 26 according to the present embodiment in the ball spline grooves 20 of the pulley 22. This makes it possible to form a pulley surface 21a and back surface 21b that are enhanced in coaxial and perpendicular properties with respect to ball spline grooves 20.

In addition, shown in FIG. 8 to FIG. 9B is a different method from the method shown in FIG. 1A to FIG. 1D of manufacturing an input disk that is a component of the variator of a toroidal continuously variable transmission.

In the method of manufacturing an input disk according to the present embodiment, firstly, the pre-working and heat treatment shown in FIG. 1A and the finish-machining of the ball spline grooves 3b shown in FIG. 1B are performed.

Next, as shown in FIG. 8, the workpiece 10 is clamped by the collet chuck 12 mounted on the lathe drive section 13, with the large diameter portion (the first back surface 5 side) facing outward, By using the ball spline grooves 3b formed in the cylindrical inner diameter portion 10a of the workpiece 10 as the machining reference, the lathe drive section 13 is rotationally driven to finish-machine the first back surface 5, the second back surface 6, and the outer surface of the workpiece 10 to have a high perpendicular property with respect to the ball spline grooves 3b.

Next, as shown in FIG. 9A, the workpiece 10 is clamped on the lathe drive section 13 via the chuck (not shown) with the large diameter portion (the first back surface 5 side) facing the lathe drive section 13 side.

Here, an annular backing plate 30 is interposed between the lathe drive section 13 and the first back surface 5, and multiple shoes 32 supported by a shoe bracket 31 supported by the lathe body (not shown) are abutted on the outer peripheral surface of the workpiece 10. As shown in FIG. 9B, the rotational center P1 of the backing plate 30 is positioned at an offset from the rotational center of the workpiece 10 (rotational center P of the lathe drive section 13).

In the above configuration, when the lathe drive section 13 rotates, a force of pushing the workpiece 10 positioned at an offset relative to the backing plate 30 against the shoes 32 is exerted to enhance the perpendicular property of the first back surface 5 of the workpiece 10 with respect to the rotational center of the workpiece 10 (rotational center P of the lathe drive section 13).

This makes it possible to perform finish-machining of the traction surface 4 of the workpiece 10 with enhanced coaxial and perpendicular properties by using the first back surface 5 of the workpiece 10, as the machining reference.

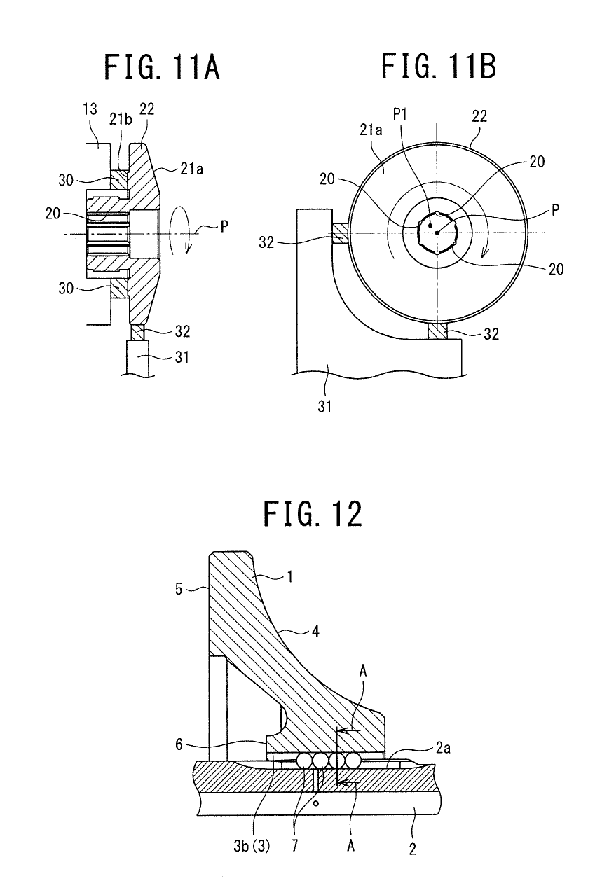

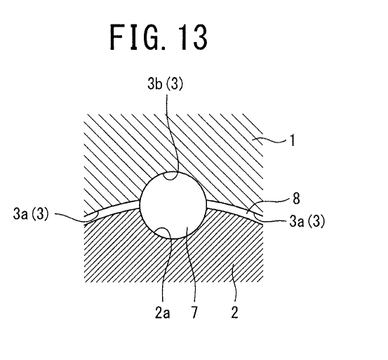

Further, the method shown in FIG. 8 and FIG. 9 is applicable to the pulley 22, shown in FIG. 10 to FIG. 11B, which is a component of a belt-type continuously variable transmission variator.

Also in the method of manufacturing an input disk according to the present embodiment, firstly, the pre-working and heat treatment shown in FIG. 1A and the finish-machining of the ball spline grooves 3b shown in FIG. 1B are performed.

Next, as shown in FIG. 10, the pulley 22 is clamped via the collet chuck 12 on the lathe drive section 13 so that the pulley surface 21a faces the lathe drive section 13 side. By using the ball spline grooves 20 formed in the cylindrical inner diameter portion of the pulley 22, as the machining reference, the lathe drive section 13 is rotationally driven to finish-machining of the back surface 21b of the pulley 22 to have a high perpendicular property with respect to the ball spline grooves 20.

Next, as shown in FIG. 11A, the pulley 22 is clamped on the lathe drive section 13 via a chuck (not shown) with the back surface 21b side facing the lathe drive section 13 side.

Also in the present embodiment, at least two circumferentially spaced backing plates 30 are interposed between the lathe drive section 13 and the back surface 21b, and multiple shoes 32 supported by a shoe bracket 31 supported by the lathe body (not shown) are abutted on the outer peripheral surface of the workpiece 10. Further, as shown in FIG. 11B, the rotational center P1 of the backing plates 30 is positioned at an offset from the rotational center of the workpiece 10 (the rotational center P of the lathe drive section 13).

In the above configuration, when the lathe drive section 13 rotates, a force of pushing the pulley 22 positioned at an offset relative to the backing plates 30 against the shoes 32 is exerted to enhance the perpendicular property of the back surface 21b of the pulley 22 with respect to the rotational center of the pulley 22 (the rotational center P of the lathe drive section 13).

This makes it possible to perform finish-machining of the pulley surface 21a of the pulley 22 with enhanced coaxial and perpendicular properties by using the back surface 21b of the pulley 22, as the machining reference.

Here, although the ball spline grooves 3b, 20 are formed in the workpiece 10 (the input disk 1, the pulley 22) in the embodiments set out above, the spirit of the present invention is not limited thereto. Involute spline grooves may be formed, and in the power transmission shaft, involute spline grooves may be formed to match these involute spline grooves.

Further, although the collet chuck 12 or chuck 23 is mounted on the lathe drive section 13 in each of the embodiments set out above, the same effect can also be produced by mounting the collet chuck 12 or chuck 23 on the drive section of a grinder (not shown).

### INDUSTRIAL APPLICABILITY

As in the foregoing, the method of manufacturing a continuously variable transmission variator component according to the present invention is useful for enhancing the coaxial and perpendicular properties of the power transmission surface with respect to the spline grooves without increasing the number of processing steps and thereby lowering the manufacturing costs of the variator components.

### REFERENCE SIGNS LIST

1 . . . Input disk, 3b . . . Ball spline groove, 4 . . . Traction surface, 5 . . . First back surface, 6 . . . Second back surface, 10 . . . Workpiece, 10a . . . Cylindrical inner diameter portion, 12 . . . Collet chuck, 13 . . . Lathe drive section, 14 . . . Chuck body, 15 . . . Radially expandable clamp section, 15a to 15f . . . Radially expandable pieces, 16 . . . Radial expansion shaft, 16a . . . Tapered portion, 17 . . . Clamp ridges, 18 . . . Master cylinder, 20 . . . Ball spline groove, 21a . . . Pulley surface, 21b . . . Back surface, 22 . . . Pulley, 23 . . . Chuck, 24 . . . Radially expandable clamp section, 25 . . . Chuck, 26 . . . Tapered outer peripheral surface, 30 . . . Backing plate, 31 . . . Shoe bracket, 32 . . . Shoe

1. A method of manufacturing a continuously variable transmission variator component, the method comprising the steps of:
performing, on a workpiece of the continuously variable transmission variator component, pre-machining of a power transmission surface on one side surface while leaving a machining allowance and pre-machining of spline holes for engaging a power transmission shaft in a central inner diameter portion while leaving machining allowance;
performing a thermal hardening process on the workpiece;
finish-machining of a plurality of spline grooves constituting the workpiece spline holes;
snugly abutting a part of a chuck mounted on a lathe or a grinder into the plurality of spline grooves and clamping the workpiece to make a rotational axis of the chuck and centers of the plurality of spline grooves of the workpiece coaxial; and
finish-machining of the power transmission surface of the workpiece using the spline grooves of the workpiece clamped by the chuck as a machining reference.

2. The method of manufacturing the continuously variable transmission variator component according to claim 1, the method further comprising finish-machining of another side surface of the workpiece using the spline grooves of the workpiece clamped by the chuck as the machining reference.

3. The method of manufacturing the continuously variable transmission variator component according to claim 1, the method further comprising finish-machining of an end face of the workpiece using the spline grooves of the workpiece clamped by the chuck as the machining reference.

4. The method of manufacturing a continuously variable transmission variator component according to any of claim 1, wherein the chuck comprises:
a plurality of radially expandable pieces formed by circumferentially dividing a hollow cylindrical member;
a plurality of clamp ridges formed on the outer peripheries of prescribed radially expandable pieces corresponding to the plurality of spline grooves to be projected into contact with groove surfaces of the spline grooves: and
a radial expansion shaft snugly abutted on the plurality of spline grooves respectively corresponding to the plurality of clamp ridges.

5. The method of manufacturing the continuously variable transmission variator component according to claim 1, wherein the chuck comprises:
a radially expandable section provided with a plurality of radially expandable pieces formed by circumferentially dividing a hollow cylindrical member provided with a fluid passage at an axial position; and
a plurality of clamp ridges formed on the outer peripheries of prescribed radially expandable pieces corresponding to the plurality of spline grooves to be projected into contact with groove surfaces of the spline grooves,
wherein the plurality of radially expandable pieces expand and hold the plurality of radially expandable pieces to abut the plurality of clamp ridges snugly in the spline grooves, respectively, upon supply of a fluid into the fluid passage.

6. The method of manufacturing the continuously variable transmission variator component according to claim 1, wherein the chuck comprises:
a shaft portion having a tapered outer peripheral surface: and
a plurality of clamp ridges formed on the tapered outer peripheral surface at a prescribed gap in a circumferential direction at positions respectively corresponding to the plurality of spline grooves to project into contact with the groove surfaces of the spline grooves,
wherein the plurality of clamp ridges are respectively abutted snugly in the spline groves by insertion of the tapered outer peripheral surface of the shaft portion into the central inner diameter portion.

7. A method of manufacturing a continuously variable transmission variator component, the method comprising the steps of:
performing, on a workpiece of the continuously variable transmission variator component, pre-machining of a power transmission surface on one side surface while leaving a machining allowance and pre-machining of spline holes for engaging a power transmission shaft in a central inner diameter portion while leaving the machining allowance;
performing a thermal hardening process on the workpiece;
finish-machining of a plurality of spline grooves constituting the workpiece spline holes;
snugly abutting a part of a chuck mounted on a lathe or a grinder against the plurality of spline grooves and clamping the workpiece to make a rotational axis of the chuck and centers of the plurality of spline grooves of the workpiece coaxial;
finish-machining of another side surface of the workpiece using the spline grooves of the workpiece clamped by the chuck as a machining reference; and
finish-machining of a power transmission surface of the workpiece using the another side surface of the workpiece as the machining reference.

8. A chuck apparatus for manufacturing a variator component, the chuck apparatus comprising:
a plurality of radially expandable pieces formed by circumferentially dividing a hollow cylindrical member;
a plurality of clamp ridges that project outward from the outer peripheries of the plurality of radially expandable pieces; and
a radial expansion shaft that expands and holds the plurality of radially expandable pieces by insertion within the plurality of radially expandable pieces,
wherein, at the time of mounting on a lathe or a grinder the workpiece of a continuously variable transmission variator component, in which a plurality of spline groove holes to be engaged with a power transmission shaft in a circumferential direction of a central inner diameter portion have been finish-machined, and performing finish-machining of a part other than the plurality of spline grooves of the workpiece,
the plurality of clamp ridges are snugly abutted in the plurality of spline grooves of the workpiece, respectively, by inserting the radial expansion shaft mounted at a rotational center of the lathe or the grinder in the plurality of radially expandable pieces.

9. A chuck apparatus for manufacturing a variator component, the chuck apparatus comprising:
a radially expandable section provided with a plurality of radially expandable pieces formed by circumferentially dividing a hollow cylindrical member provided with a fluid passage at an axial center position; and
a plurality of clamp ridges that project outward the outer peripheries of the plurality of radially expandable pieces,
wherein, at the time of mounting on a lathe or a grinder the workpiece of a continuously variable transmission variator component, in which a plurality of spline groove holes to be engaged with a power transmission shaft in a circumferential direction of a central inner diameter portion have been finish-machined, and performing finish-machining of a part other than the spline grooves of the workpiece, the plurality of clamp ridges are snugly abutted in the plurality of spline grooves of the workpiece, respectively, by mounting the radially expandable section at the rotational center of the lathe or the grinder and supplying a fluid into the fluid passage to expand and hold the plurality of radially expandable pieces.

10. A chuck apparatus for manufacturing a variator component, the chuck apparatus comprising:
a shaft portion having a tapered outer peripheral surface; and
a plurality of clamp ridges that project at a prescribed gap in a circumferential direction of the tapered outer peripheral surface,
wherein, at the time of mounting on a lathe or a grinder the workpiece of a continuously variable transmission variator component, in which a plurality of spline groove holes to be engaged with a power transmission shaft in a circumferential direction of a central inner diameter portion have been finish-machined, and performing finish-machining of a part other than the plurality of spline grooves of the workpiece,
the plurality of clamp ridges are snugly abutted in the plurality of spline grooves of the workpiece, respectively, by inserting the shaft portion mounted at the rotational center of the lathe or the grinder into the centeral inner diameter portion.
